(19) United States
(12) Patent Application Publication
(10) Pub. No.: US 2021/0108930 A1
(43) Pub. Date: Apr. 15, 2021

(54) METHOD AND APPARATUS FOR RECOMMENDING A TRAVEL PLAN, DEVICE AND STORAGE MEDIUM

(71) Applicant: BEIJING BAIDU NETCOM SCIENCE TECHNOLOGY CO., LTD., Beijing (CN)

(72) Inventors: Hao LIU, Beijing (CN); Hui XIONG, Beijing (CN)

(21) Appl. No.: 16/864,458

(22) Filed: May 1, 2020

(30) Foreign Application Priority Data
Oct. 10, 2019 (CN) 201910958322.X

(51) Int. Cl. G01C 21/34; G06Q 10/02; G06Q 50/30; G06Q 50/14

(52) U.S. Cl. CPC G01C 21/3423; G01C 21/3453; G06Q 50/14; G06Q 50/30; G06Q 10/02

(57) ABSTRACT

The present disclosure provides a method and an apparatus for recommending a travel plan, a device and a storage medium, and relates to the field of computer technology. A query request sent by a terminal device for a travel plan is received, where the query request includes travel information. At least one candidate mixed travel plan is obtained from a travel plan database according to the travel information. A real-time travel cost parameter of the at least one candidate mixed travel plan is obtained and travel cost information of the at least one candidate mixed travel plan is obtained according to the travel cost parameter. An optimum mixed travel plan is selected from the at least one candidate mixed travel plan according to the travel cost information and sent to the terminal device. Candidate mixed travel plans are stored in the travel plan database.

### CROSS-REFERENCE TO RELATED APPLICATIONS

This application claims priority to Chinese Patent Application No. 201910958322.X, which was filed on Oct. 10, 2019 and titled “method and apparatus for recommending a travel plan, device and storage medium”. The disclosure of the above patent application is incorporated herein by reference in its entirety.

### TECHNICAL FIELD

The present disclosure relates to the field of computer technology and, in particular, to the field of travel plan recommendation technology.

### BACKGROUND

As the urban traffic environment is getting more and more complex, the travel needs of users are becoming more and more diversified. In many scenarios, a single mode of travel can hardly meet the diversified travel needs of users. For example, many users may resort to a mixed travel mode of bus and taxi.

In prior art, when a user searches for a travel plan, only a travel plan of single travel mode is recommended, lacking a method for providing a mixed travel plan promptly and accurately, and failing to meet the diversified needs of users for a mixed travel, such as travel duration, the number of transfers, travel cost and comfort level etc.

### SUMMARY

The present disclosure provides a method and an apparatus for recommending a travel plan, a device and a storage medium, so as to improve the acquisition speed and accuracy of an optimum mixed travel plan and meet the needs of users for mixed travel.

A first aspect of the present disclosure provides a method for recommending a travel plan, including:

receiving a query request sent by a terminal device for a travel plan, the query request including travel information;

obtaining at least one candidate mixed travel plan from a travel plan database according to the travel information;

obtaining a real-time travel cost parameter of the at least one candidate mixed travel plan, and obtaining travel cost information of the at least one candidate mixed travel plan according to the travel cost parameter; and

selecting an optimum mixed travel plan from the at least one candidate mixed travel plan according to the travel cost information, and sending the optimum mixed travel plan to the terminal device.

Through the above method, a prompt acquisition of a mixed travel plan can be accomplished, and the query latency is reduced; a real-time estimation of the travel costs of the candidate mixed travel plans is performed to enable a better timeliness of the recommended optimum mixed travel plan and a higher accuracy of travel plan recommendation.

Furthermore, the travel information includes an origin, a destination and a travel time;

the obtaining at least one candidate mixed travel plan from a travel plan database according to the travel information, includes:

obtaining at least one candidate mixed travel plan with the same origin, destination and travel time from the travel plan database.

Through the above method, at least one candidate mixed travel plan can be accurately found from the travel plan database.

Furthermore, the travel cost parameter includes at least one of a total price, a total time consumption a walking distance and a number of transfers.

Furthermore, the method further includes:

obtaining a plurality of pairs of a preset origin and a preset destination;

obtaining candidate mixed travel plans for different times according to each pair of the preset origin and the preset destination, and saving in the travel plan database.

Through the above method, candidate mixed travel plans with different preset origins and preset destinations for different times can be obtained in advance, so as to quickly provide a corresponding candidate mixed travel plan when queried.

Furthermore, the obtaining candidate mixed travel plans for different times according to each pair of the preset origin and the preset destination includes:

obtaining at least one bus-only travel plan according to each pair of the preset origin and the preset destination;

obtaining a plurality of candidate transfer points according to transfer sections of the at least one bus-only travel plan;

creating a preselected transfer plan according to the preset origin, the preset destination and each of the candidate transfer points;

obtaining travel cost information of each preselected transfer plan for the different times;

selecting at least one preselected transfer plan for each of the times according to the travel cost information as the candidate mixed travel plan.

Through the above method, it is possible to obtain candidate mixed travel plans with different preset origins and preset destinations for different times.

Furthermore, the obtaining a plurality of candidate transfer points according to transfer sections of the at least one bus-only travel plan includes:

for each bus-only travel plan, obtaining at least one of a start bus stop, an end bus stop, a first bus stop within a preset distance from the start bus stop and a second bus stop within the preset distance from the end bus stop, for each of the transfer sections of the bus-only travel plan, as the candidate transfer points.

Through the above method, candidate transfer points can be provided as many as possible, so that a better preselected transfer plan can be dug out therefrom

Furthermore, the creating a preselected transfer plan according to the preset origin, the preset destination and each of the candidate transfer points includes:

creating a preselected transfer plan with a travel by bus from the preset origin to the candidate transfer point and a travel by taxi from the candidate transfer point to the preset destination; and/or

creating a preselected transfer plan with a travel by taxi from the preset origin to the candidate transfer point and a travel by bus from the candidate transfer point to the preset destination.

Furthermore, the obtaining travel cost information of each preselected transfer plan for different times includes:

for each of the times, obtaining a travel cost parameter of each preselected transfer plan at the time, and obtaining travel cost information at the time according to the travel cost parameter at the time;

the selecting at least one preselected transfer plan for each of the times according to the travel cost information includes:

for each of the times, selecting at least one preselected transfer plan according to travel cost information of preselected transfer plans at the time.

Furthermore, after the selecting at least one preselected transfer plan for each of the times according to the travel cost information, further including:

determining whether a total time consumption of the preselected transfer plan is less than a total time consumption of the bus-only travel plan, and/or whether a total price of the preselected transfer plan is less than a total price of a taxi-only travel plan;

deleting the preselected transfer plan on a negative determination.

A second aspect of the present disclosure provides an apparatus for recommending a travel plan, including:

a receiving module, configured to receive a query request sent by a terminal device for a travel plan, the query request including travel information;

a querying module, configured to obtain at least one candidate mixed travel plan from a travel plan database according to the travel information;

a processing module, configured to obtain a real-time travel cost parameter of the at least one candidate mixed travel plan, and obtaining travel cost information of the at least one candidate mixed travel plan according to the travel cost parameter; select an optimum mixed travel plan from the at least one candidate mixed travel plan according to the travel cost information, and

a sending module, configured to send the optimum mixed travel plan to the terminal device.

A third aspect of the present disclosure provides an electronic device, including:

at least one processor; and

a memory communicatively connected to the at least one processor; wherein,

the memory stores thereon instructions executable by the at least one processor, the instructions are executed by the at least one processor to enable the at least one processor to carry out the method described in the first aspect.

A fourth aspect of the present disclosure provides a non-transitory computer readable storage medium with computer instructions stored thereon, wherein the computer instructions are used to enable a computer to carry out the method described in the first aspect.

A fifth aspect of the present disclosure provides a computer program which includes program codes, when the program is run by a computer, the program codes carry out the method described in the first aspect.

A sixth aspect of the present disclosure provides a method for recommending a travel plan, including:

receiving a query request sent by a terminal device for a travel plan, the query request including travel information;

obtaining an optimum mixed travel plan from a travel plan database according to the travel information, and sending the optimum mixed travel plan to the terminal device.

An embodiment of the disclosure described above has the following advantages or beneficial effects. A query request sent by a terminal device for a travel plan is received, where the query request includes travel information. At least one candidate mixed travel plan is obtained from a travel plan database according to the travel information. A real-time travel cost parameter of the at least one candidate mixed travel plan is obtained, and travel cost information of the at least one candidate mixed travel plan is obtained according to the travel cost parameter. An optimum mixed travel plan is selected from the at least one candidate mixed travel plan according to the travel cost information, and sent to the terminal device. In embodiment of the present disclosure, candidate mixed travel plans are stored in the travel plan database, a prompt acquisition of a mixed travel plan may be accomplished by querying the travel plan database and the querying latency is reduced, and real-time estimation of the travel costs of the candidate mixed travel plans is performed to enable a better timeliness of the recommended optimum mixed travel plan and a higher accuracy of travel plan recommendation, which can effectively shorten travel duration, reduce the number of transfers, lower travel cost and improve comfort, and then improve the travel experience of users.

Other effects of the above optional implementations will be described below in conjunction with specific embodiments.

### BRIEF DESCRIPTION OF DRAWINGS

The drawings are for better understanding of the present solution and do not constitute a limitation to the disclosure, where:

FIG. 1 is a schematic diagram of a system structure provided by an embodiment of the present disclosure;

FIG. 2 is a flowchart of a method for recommending a travel plan provided by an embodiment of the present disclosure;

FIG. 3 is a flowchart of a method for recommending a travel plan provided by another embodiment of the present disclosure;

FIG. 4 is a flowchart of a method for recommending a travel plan provided by yet another embodiment of the present disclosure;

FIG. 5 is a structural diagram of an apparatus for recommending a travel plan provided by an embodiment of the present disclosure; and

FIG. 6 is a block diagram of an electronic device for implementing a method for recommending a travel plan of an embodiment of the present disclosure.

### DESCRIPTION OF EMBODIMENTS

The exemplary embodiments of the present disclosure are explained hereinafter with reference to the accompanying drawings, and various details of the embodiments of the present disclosure are included therein for understanding, which should be regarded as being exemplary. Therefore, those ordinary skilled in the art should understand that various changes or modifications can be made to the embodiments described herein without deviating from the scope and the spirit of the present disclosure. Similarly, for clarity and concise, the description to functions and structures which are commonly known are omitted from the description below.

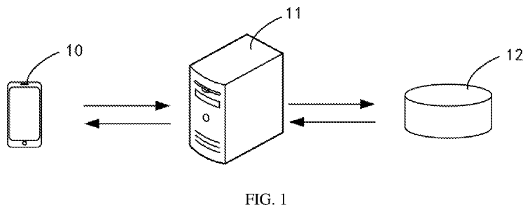

A method for recommending a travel plan provided by an embodiment of the present disclosure is applied to a communication system as shown in FIG. 1. The communication system includes a terminal device 10, a service end 11 and a travel plan database 12, where the travel plan database 12 stores therein candidate mixed travel plans corresponding to travel information, where a mixed travel plan refers to a travel plan using at least two means of transportation. The terminal device 10, which may be a lap-top computer, a tablet computer, a personal digital assistant, a cellular phone, a smart phone, a wearable device, a navigator or the like, is communicatively connected to the service end 11 to send a query request for a travel plan. The query request may include travel information The service end 11, which may be a single network server, a server group consists of a plurality of network servers, or a cloud computing based cloud server consisting of numerous computers or network servers, is communicatively connected to the travel plan database 12 to obtain at least one candidate mixed travel plan from the travel plan database 12 according to the travel information, then select an optimum travel plan from the at least one candidate mixed travel plan, and send the same to the terminal device 10, thus the process for recommending a travel plan is fulfilled.

The process for recommending a travel is described in detail below with reference to specific embodiments.

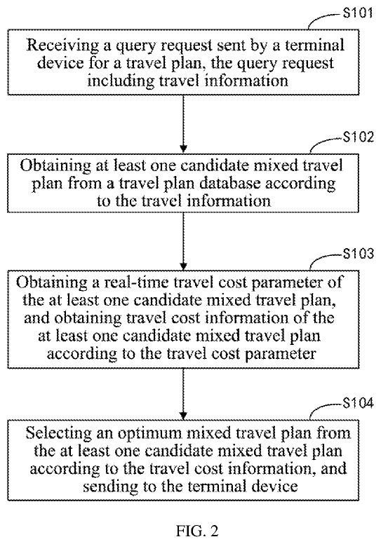

An embodiment of the present disclosure provides a method for recommending a travel plan. FIG. 2 Is a flowchart of the method for recommending a travel plan provided by the embodiment of the present disclosure. The executive body of the method for recommending a travel plan is a service end. As shown in FIG. 2, the specific steps of the method for recommending a travel plan are as follows:

S101: receiving a query request sent by a terminal device for a travel plan, the query request including travel information.

In the embodiment, when a user needs to query for a travel plan, the user may send a query request to a service end by means of a terminal device, where the query request carries travel information. Specifically, the travel information may include but is limited to an origin, a destination and a travel time.

S102: obtaining at least one candidate mixed travel plan from a travel plan database according to the travel information.

In the present embodiment a mixed travel plan refers to a travel plan using at least two means of transportation, such as a mixed travel plan using a bus and a taxi, which requires less total time consumption compared with a bus-only travel plan, and requires lower total price compared with a taxi-only travel plan. A mixed travel plan with a bus and a taxi is explained in the present embodiment as an example.

In the present embodiment, the travel plan database stores in advance candidate mixed travel plans which include candidate mixed travel plans with different origins and destinations at different times. For example, the candidate mixed travel plans may be stored in the form of key-value pairs, where the key is an origin, a destination and a travel time, and the value is at least one candidate mixed travel plan. When the query request is received, the travel information carried therein can be parsed out, and then a query is carried out in the travel plan database. Specifically, at least one candidate mixed travel plan with the same origin, destination and travel time is retrieved from the travel plan database. Furthermore, the travel plan database can be traversed according to the origin, the destination and the travel time included in the travel information to query for the key, and the value corresponding to the key is returned.

S103: obtaining a real-time travel cost parameter of the at least one candidate mixed travel plan, and obtaining travel cost information of the at least one candidate mixed travel plan according to the travel cost parameter.

In the present embodiment, more than one candidate mixed travel plan may be obtained from the travel plan database according to the travel information, therefore it is necessary to determine which one is the optimum mixed travel plan. In the present embodiment, a real-time travel cost parameter of each candidate mixed travel plan is obtained, where the travel cost parameter may include but not limited to at least one of a total price, a total time consumption, a walking distance and a number of transfers. It should be noted that the travel cost parameter may be different for different travel times. For example, a total time consumption during a high peak of travel is generally more than a time consumption during a low peak. Moreover, a total price may fluctuate due to traffic congestion or other causes. Therefore, the travel cost parameter obtained in the present embodiment is a real-time travel cost parameter, where the real-time travel cost parameter virtually refers to the real-time travel cost parameter corresponding to the travel time in the travel information. As a matter of course, in a case that the travel time is close to the current time, the travel cost parameter for the current time may be approximately used as the real-time travel cost parameter for the travel time. In an optional embodiment, the travel time may be partitioned according to a preset time span, for example, every one hour may be regarded as a time.

Furthermore, after the real-time travel cost parameter of each candidate mixed travel plan is obtained, the travel cost information of each candidate mixed travel plan may be obtained according to the travel cost parameter. In an optional embodiment, the travel cost information may be calculated according to the following formula:

cost=α·time+β·price+γ·distance_walk+δ·trans_num

where the “cost” is the travel cost information, the “time” is the total time consumption, the “price” is the total price, the “distance_walk” is the walking distance, the “trans_num” is the number of transfers, and the α, β, γ and δ are coefficients.

S104: selecting an optimum mixed travel plan from the at least one candidate mixed travel plan according to the travel cost information, and sending the optimum nixed travel plan to the terminal device.

In the present embodiment, after the travel cost information of each candidate mixed travel plan is obtained, an optimum mixed travel plan may be selected from the various candidate mixed travel plans according to the travel cost information of each candidate mixed travel plan. In the present embodiment, the candidate mixed travel plan with the lowest travel cost may be regarded as the optimum mixed travel plan, which is then sent to the terminal device and displayed on a display component of the terminal device, or played by voice broadcast.

In the method for recommending a travel plan provided by the present embodiment, a query request sent by a terminal device for a travel plan is received, where the query request includes travel information, at least one candidate mixed travel plan is obtained from a travel plan database according to the travel information, a real-time travel cost parameter of the at least one candidate mixed travel plan is obtained, and travel cost information of the at least one candidate mixed travel plan is obtained according to the travel cost parameter, and an optimum mixed travel plan is selected from the at least one candidate mixed travel plan according to the travel cost information and sent to the terminal device. In the present embodiment, candidate mixed travel plans are stored in the travel plan database, a prompt acquisition of a mixed travel plan can be accomplished by querying the travel plan database and the querying latency is reduced, and real-time estimation of the travel costs of the candidate mixed travel plans is performed to enable a better timeliness of the recommended optimum mixed travel plan and a higher accuracy of travel plan recommendation, which can effectively shorten travel duration, reduce the number of transfers, lower travel cost and improve comfort, and then improve the travel experience of users.

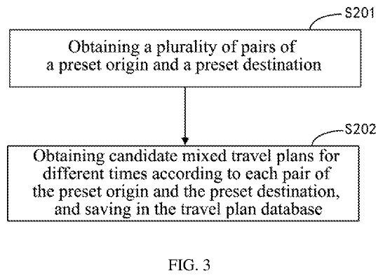

Based on any one of the above embodiments, as shown in FIG. 3, a method for recommending a travel plan is provided in another embodiment of the present disclosure, which may further include:

S201: obtaining a plurality of pairs of a preset origin and a preset destination;

S202: obtaining candidate mixed travel plans for different times according to each pair of the preset origin and the preset destination, and saving in the travel plan database.

The present embodiment provides a solution to obtain the candidate mixed travel plans in travel plan data. In the present embodiment, a plurality of pairs of a preset origin and a preset destination may be obtained, where the plurality of pairs of the preset origin and the preset destination are not two random points on the map. For example, points in farmland or the like on the map are usually irrelevant. Instead, the plurality of pairs of the preset origin and the preset destination in the present embodiment are required to be effective points. A numerous of origins and destinations which have been queried for by users in history may be collected to serve as preset origins and preset destinations, where each pair of the preset origin and the preset destination includes an x coordinate and a y coordinate of the preset origin, and an x coordinate and a y coordinate of the preset destination. It should be noted that the coordinates of the preset origin and the preset destination may be determined by gridding, namely all points in a certain grid on the map are represented by the same coordinates. For example, the coordinates of all the points in an area of 100 meters*100 meters are replaced by the coordinates of the central point of the area. Correspondingly, the coordinates of the origin and the destination included in the travel information in S101 are also processed in the same manner.

After the plurality of pairs of the preset origin and the preset destination are obtained, candidate mixed travel plans for different times may be obtained for each pair of the preset origin and the preset destination. For example, for a preset origin O and a preset destination D, the candidate mixed travel plans for a first time are plans 1, 2 and 3, the candidate mixed travel plans for a second time are plans 4, 5 and 6 . . . then these candidate mixed travel plans are stored in the travel plan database for subsequent query. In an embodiment, the candidate mixed travel plans are stored in a form of key-value pairs.

It should be noted that S201-S202 and S101-S104 may be executed by a same server, or by different servers.

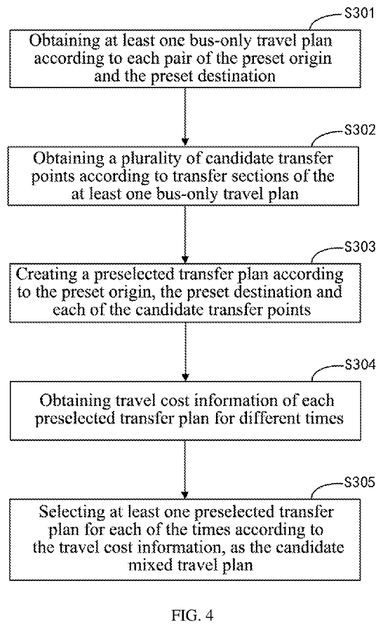

Based on the above embodiment, as shown in FIG. 4, the obtaining candidate mixed travel plans for different times according to each pair of the preset origin and the preset destination in S202, may specifically include:

S301: obtaining at least one bus-only travel plan according to each pair of the preset origin and the preset destination.

In the present embodiment, for a pair of the preset origin O and the preset destination D, at least one bus-only travel plan may be obtained according to the preset origin O and the preset destination D. It should be noted that, between the preset origin O and the preset destination D, there exists no direct bus-only travel plan, or there exists a direct bus-only travel plan but it is not recommended due to long time consumption or other reasons. Namely, the bus-only travel plan obtained in S301 includes at least one transfer. For example, a bus-only travel plan 1 obtained requires transfers at a bus stop A and a bus stop B, that is to say the bus travel plan 1 includes three transfer sections: a section from the preset origin O to the bus stop A, a section from the bus stop A to the bus stop B, and a section from the bus stop B to the preset destination D. In the present embodiment, a bus travel plan recommending system may be queried according to a preset origin and a preset destination for a bus-only travel plan, and the bus travel plan recommending system may return at least one recommended bus-only travel plan (for example, recommended according to a total time consumption, a number of transfers or a walking distance etc.)

S302: obtaining a plurality of candidate transfer points according to transfer sections of the at least one bus travel plan.

In the present embodiment, the candidate transfer points are obtained according to the transfer sections of the obtained bus-only travel plan, to create subsequent preselected transfer plans.

In an optional embodiment, for each bus-only travel plan, at least one of an start bus stop, an end bus stop, a first bus stop within a preset distance from the start bus stop and a second bus stop within the preset distance from the end bus stop is obtained for each of the sections of the bus-only travel plan, as the candidate transfer points.

In the present embodiment, in order to increase the number of candidate transfer points so as to find more reasonable and better transfer points therefrom, the candidate transfer points may be selected from each of the transfer sections, where the candidate transfer points may include the start bus stop and the end bus stop of the transfer section. Furthermore, to find out more alternative plans, one or more bus stops which are comparatively close to the start bus stop may be obtained as alternative bus stops to the start bus stop, and one or more bus stops which are comparatively close to the end bus stop may be obtained as alternative bus stops to the end bus stop. The alternative plans are feasible to some extent since these alternative bus stops are close to the start bus stop or the end bus stop. For the obtaining of an alternative bus stop, any bus stop within a preset range centered by the start bus stop or the end bus stop is eligible, and preferably, the nearest bus stop is selected, where the preset range may be 0.5 kilometer, 1 kilometer, 1.5 kilometers or the like. Moreover in the present embodiment, an end bus stop of a previous transfer section and a start bus stop of a next transfer section may be a same bus stop, however, they may be regarded as different transfer points since they serve for different purposes in respective transfer sections. When an end bus stop of a previous transfer section and a start bus stop of a next transfer section are different (for example, need to walk for a distance), the start bus stops and the end bus stops of the transfer sections also need to be obtained respectively.

S303: creating a preselected transfer plan according to the preset origin, the preset destination and each of the candidate transfer points.

In the present embodiment, after the candidate transfer points are obtained, a preselected transfer plan may be created according to the preset origin, the preset destination and each candidate transfer point.

In an optional embodiment, a preselected transfer plan may be created with a travel by bus from the preset origin to the candidate transfer point and a travel by taxi from the candidate transfer point to the preset destination; and/or a preselected transfer plan can be created with a travel by taxi from the preset origin to the candidate transfer point and a travel by bus from the candidate transfer point to the preset destination.

For example, assuming that there is a candidate transfer point a and a candidate transfer point b between a preset origin O and a preset destination D, then a preselected transfer plan may be created as follows: a bus is taken from the preset origin O to the candidate transfer point a, and a taxi is taken from the candidate transfer point a to the preset destination D; a taxi is taken from the preset origin O to the candidate transfer point a, and a bus is taken from the candidate transfer point a to the preset destination D; a bus is taken from the preset origin O to the candidate transfer point b, and a taxi is taken from the candidate transfer point h to the preset destination D; a taxi is taken from the preset origin O to the candidate transfer point b, and a bus is taken from the candidate transfer point b to the preset destination D.

S304: obtaining travel cost information of each preselected transfer plan for different times.

In the present embodiment, for the preselected transfer plans created, it is necessary to select therefrom at least one as a candidate mixed travel plan, and save the sane to the travel plan database. In the present embodiment, the same method as described in S103 may be used to estimate a travel cost of each preselected travel plan. Since the travel cost information is different for different times, for each of the different times, a preferable preselected transfer plan may be obtained for the time, namely, the travel cost of each preselected transfer plan may be estimated based on different times.

In an optional embodiment, for each of the different times, a travel cost parameter of each preselected transfer plan for the time is obtained, and travel cost information for the time is obtained according to the travel cost parameter for the time.

In the present embodiment, when obtaining a travel cost parameter of a preselected transfer plan for a time, an average travel cost parameter for the time may be selected, where the average travel cost parameter may be an average of travel cost parameters for the sane time of a preset number of days in historical data.

S305: selecting at least one preselected transfer plan for each of the times according to the travel cost information, as the candidate mixed travel plan.

In the present embodiment, for each of the times, at least one preselected transfer plan may be selected according to travel cost information of the preselected transfer plans for the time. For example, for the preset origin O and the preset destination D, three preselected transfer plans with a lowest travel cost are selected for each of the times as candidate mixed travel plans, and stored in the travel plan database.

Based on the above embodiment, optionally, if the at least one candidate mixed travel plan with the same origin, destination and travel time is not found in the travel plan database in S102, then S301-S305 may be executed to obtain, where the origin and the destination included in the travel information are selected as the preset origin and the preset destination, and the travel costs of the preselected transfer plans are estimated only for the travel time included in the travel information, and an optimum preselected transfer plan is selected as the optimum mixed travel plan and sent to the terminal device. Furthermore, travel cost information of each preselected transfer plan may be further obtained for different times, and at least one preselected transfer plan may be selected for each of the times as the candidate mixed travel plan and stored in the travel plan database for subsequent queries.

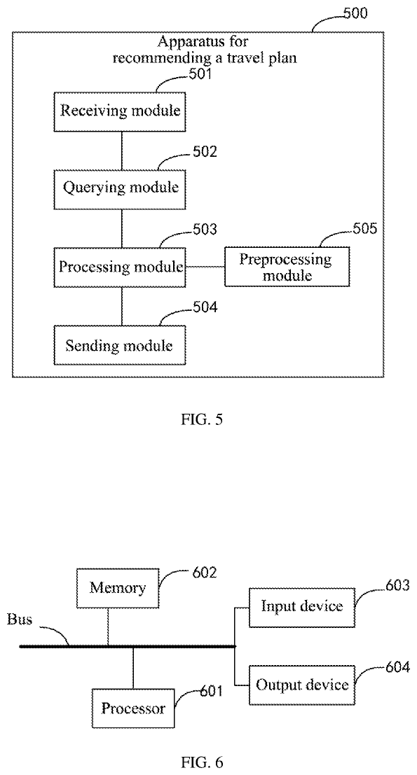

An embodiment of the present disclosure provides an apparatus for recommending a travel plan. FIG. 5 is a structural diagram of an apparatus for recommending a travel plan provided by an embodiment of the present disclosure. As shown in FIG. 5, the apparatus 500 for recommending a travel plan includes a receiving module 501, a querying module 502, a processing module 503 and a sending module 504.

The receiving module 501 is configured to receive a query request sent by a terminal device for a travel plan, the query request including travel information.

The querying module 502 is configured to obtain at least one candidate mixed travel plan from a travel plan database according to the travel information.

The processing module 503 is configured to obtain a real-time travel cost parameter of the at least one candidate mixed travel plan, and obtain travel cost information of the at least one candidate mixed travel plan according to the travel cost parameter; select an optimum mixed travel plan from the at least one candidate mixed travel plan according to the travel cost information.

The sending module 504 is configured to send the optimum mixed travel plan to the terminal device.

Based on the above embodiment, the travel information includes an origin, a destination and a travel time;

the querying module 502 is configured to obtain at least one candidate mixed travel plan that has the same origin, destination and travel time from the travel plan database.

Based on any one of the above embodiments, the travel cost parameter includes at least one of a total price, a total time consumption, a walking distance and a number of transfers.

Based on any one of the above embodiments, the apparatus 500 further includes a preprocessing module 505 which is configured to:

obtain a plurality of pairs of a preset origin and a preset destination;

obtain, according to each pair of the preset origin and the preset destination, candidate mixed travel plans for different times, and save in the travel plan database.

Based on any one of the above embodiments, the preprocessing module 505 is configured to:

obtain at least one bus-only travel plan according to each pair of the preset origin and the preset destination;

obtain a plurality of candidate transfer points according to transfer sections of the at least one bus-only travel plan;

create a preselected transfer plan according to the preset origin, the preset destination and each of the candidate transfer points;

obtain travel cost information of each preselected transfer plan for the different times;

select, according to the travel cost information, at least one preselected transfer plan for each of the times as the candidate mixed travel plan.

Based on any one of the above embodiments, the preprocessing module 505 is configured to:

for each bus-only travel plan, obtain at least one of a start bus stop, an end bus stop, a first bus stop within a preset distance from the start bus stop and a second bus stop within the preset distance from the end bus stop, for each of the transfer sections of the bus-only travel plan, as the candidate transfer points.

Based on any one of the above embodiments, the preprocessing module 505 is configured to:

create a preselected transfer plan with a travel by bus from the preset origin to the candidate transfer point and a travel by taxi from the candidate transfer point to the preset destination; and/or

create a preselected transfer plan with a travel by taxi from the preset origin to the candidate transfer point, and a travel by bus from the candidate transfer point to the preset destination.

Based on any one of the above embodiments, the preprocessing module 505 is configured to:

for each of the times, obtain a travel cost parameter of each preselected transfer plan for the time, and obtain travel cost information for the time according to the travel cost parameter for the time;

the selecting at least one preselected transfer plan for each of the tunes according to the travel cost information includes:

for each of the times, selecting at least one preselected transfer plan according to travel cost information of preselected transfer plans for the time.

Based on any one of the above embodiments, after the selecting at least one preselected transfer plan for each of the times according to the travel cost information, the preprocessing module 505 is further configured to:

determine whether a total time consumption of the preselected transfer plan is less than a total time consumption of the bus-only travel plan, and/or whether a total price of the preselected transfer plan is less than a total price of a taxi-only travel plan;

delete the preselected transfer plan on a negative determination.

The apparatus for recommending a travel plan may be specifically configured to carry out the method embodiments provided by FIG. 2-FIG.4, the specific functions of which will not be provided herein again.

The apparatus for recommending a travel plan provided by the present embodiment, receives a query request sent by a terminal device for a travel plan, where the query request includes travel information, obtains at least one candidate mixed travel plan from a travel plan database according to the travel information, obtains a real-time travel cost parameter of the at least one candidate mixed travel plan and obtains travel cost information of the at least one candidate mixed travel plan according to the travel cost parameter, and selects an optimum mixed travel plan from the at least one candidate mixed travel plan according to the travel cost information and sends the same to the terminal device. In the present embodiment, candidate mixed travel plans are stored in the travel plan database, a prompt acquisition of a mixed travel plan can be accomplished by querying the travel plan database and the querying latency is reduced, and real-time estimation of the travel costs of the candidate mixed travel plans is performed to enable a better timeliness of the recommended optimum mixed travel plan and a higher accuracy of travel plan recommendation, which can effectively shorten travel duration, reduce the number of transfers, lower travel cost and improve comfort, and then improve the travel experience of users.

The present disclosure further provides an electronic device and a readable storage medium.

FIG. 6 is a block diagram of an electronic device for implementing a method for recommending a travel plan of an embodiment of the present disclosure. The electronic device is intended to represent digital computers in various forms, such as a laptop computer, a desktop computer, a workstation, a personal digital assistant, a server, a blade server, a mainframe computer, or other suitable computers. The electronic device may also represent mobile devices in various forms, such as a personal digital assistant, a cellular phone, a smart phone, a wearable device, or other similar computing devices. The components shown herein, connections and relationships therebetween, and functions thereof are merely examples and are not intended to limit the implementation of the present disclosure described and/or required herein.

As shown in FIG. 6, the electronic device includes: one or more processor 601, a memory 602, and interfaces for connecting respective components, which include a high-speed interface and a low-speed interface. The respective components are connected to each other via different buses, and can be installed on a common motherboard or installed in other ways as needed. The processor may process instructions executed within the electronic device, including instructions stored in or on the memory to display graphical information of GUI on an external input/output device, such as a display device coupled to the interface. In other embodiments, multiple processors and/or multiple buses may be used with multiple memories when necessary. Similarly, multiple electronic devices can be connected, and each device provides a part of necessary operations (for example, as a server array, a group of blade servers, or a multi-processor system). In FIG. 6, one processor 601 is taken as an example.

The memory 602 is a non-transitory computer readable storage medium provided by the present disclosure, where the memory has instructions stored thereon, which are executable by the at least one processor to enable the at least one processor to carry out the method for recommending a travel plan provided by the present disclosure. The non-transitory computer readable storage medium of the present disclosure stores computer instructions thereon, the computer instructions are used to enable a compiler to carry out the method provided by the present disclosure.

The memory 602, as a non-transitory computer readable storage medium, may be used to store non-transitory software programs, non-transitory computer executable programs and modules, such as program instructions/modules (for example, the receiving module 501, the querying module 502, the processing module 503, the sending module 504 and the preprocessing module 505 shown in FIG. 5) corresponding to the method for recommending a travel plan in the embodiments of the present disclosure. The processor 601, by executing the non-transitory software programs, instructions and modules stored in the memory 602, executes various functional applications and data processing of the server, namely, carries out the method for recommending a travel plan in the above method embodiments.

The memory 602 may include a program storage area and a data storage area, where the program storage area may store an operating system and application programs required by at least one function, and the data storage area may store data created according to the use of the electronic device of the method for recommending a travel plan, or the like. Additionally, the memory 602 may include a high-speed random access memory, and may also include a non-transitory memory, such as at least one of a magnetic disk storage device, a flash memory device, or other non-transitory solid state storage device. In some embodiments, the memory 602 may optionally include a memory disposed remotely with respect to the processor 601, and these remote memories may be connected to the electronic device of the method for recommending a travel plan via a network. Examples of the network include but are not limited to the Internet, intranet, local area network, mobile communication network, or a combination thereof.

The electronic device of the method for recommending a travel plan may further include: an input device 603 and an output device 604. The processor 601, the memory 602, the input device 603, and the output device 604 may be connected via a bus or the like. In FIG. 6, connection via a bus is taken as an example.

The input device 603, such as a touch screen, a keypad, a mouse, a trackpad, a touchpad, an indicator bar, one or more mouse buttons, trackballs, joysticks and other input device, can receive input numeric or character information, and generate key signal input related to user settings and function control of the electronic device of the method for recommending a travel plan. The output device 604 may include a display device, an auxiliary lighting apparatus (for example, an LED), a tactile feedback apparatus (for example, a vibration motor) or the like. The display device may include but is not limited to, a liquid crystal display (LCD), a light emitting diode (LED) display, and a plasma display. In some embodiments, the display device may be a touch screen.

Various embodiments of the systems and techniques described herein may be implemented in a digital electronic circuit system, an integrated circuit system, an ASIC (Application Specific Integrated Circuit), computer hardware, firmware, software, and/or a combination thereof. These various implementations may include: to implement in one or more computer programs which may be executed and/or interpreted on a programmable system including at least one programmable processor, where the programmable processor may be a special or general purposed programmable processor which may receive instructions and data from a storage system, at least one input device and at least one output device and store the data and the instructions in the storage system, the at least one input device and the at least one output device.

These computer programs (also referred to as programs, software, software applications, or codes) include machine instructions of programmable processors, and can be implemented using a high level process and/or an object-oriented programming language, and/or an assembly/machine language. As used herein, the terms “a machine readable medium” or “a computer readable medium” refers to any computer program product, device, and/or apparatus (for example, a disk, an optical disk, a memory, a programmable logic device (PLD)) used to provide machine instructions and/or data to a programmable processor, which includes a machine readable medium that receives machine instructions as machine readable signals. The term “a machine readable signal” refers to any signal used to provide machine instructions and/or data to a programmable processor.

In order to provide interaction with a user, the systems and techniques described herein may be implemented on a computer having: a display device (for example, a CRT (Cathode Ray Tube) or an LCD (Liquid Crystal Display) monitor) for displaying information to a user; and a keyboard and a pointing device (for example, a mouse or a trackball) through which a user could provide inputs to a computer. Other kinds of devices may also be used to provide interaction with a user; for example, the feedback provided to a user may be any form of a sensory feedback (for example, a visual feedback, an auditory feedback, or a tactile feedback); and an input from a user may be received in any form (including an acoustic input, a voice input, or a tactile input).

The systems and techniques described herein may be implemented in a computer system including a background component (for example, as a data server), a computer system including a middleware component (for example, an application server), a computing system including a front-end component (for example, a user computer with a graphical user interface or a web browser through which a user may interact with the systems and techniques described herein), or a computer system including any combination of the background component, the middleware component, and the front-end component. The components of the system may be interconnected by digital data communication (for example, a communication network) of any form or medium. Examples of the communication network include: a local area network (LAN), a wide area network (WAN), and the Internet.

A computer system may include a client and a server. The client and the server are usually remote from each other and usually interact via a communication network. The relationship between a client and a server is generated by computer program running on corresponding computers and having a client-server relationship with each other.

According to the technical solution according to the embodiments of the present disclosure, a query request sent by a terminal device for a travel plan is received, where the query request includes travel information, at least one candidate mixed travel plan is obtained from a travel plan database according to the travel information, a real-time travel cost parameter of the at least one candidate mixed travel plan is obtained and travel cost information of the at least one candidate mixed travel plan is obtained according to the travel cost parameter, and an optimum mixed travel plan is selected from the at least one candidate mixed travel plan according to the travel cost information and sent to the terminal device. In the present embodiment, candidate mixed travel plans are stored in the travel plan database, a prompt acquisition of a mixed travel plan may be accomplished by querying the travel plan database and the querying latency is reduced, real-time estimation of the travel costs of the candidate mixed travel plans is performed to enable a better timeliness of the recommended optimum mixed travel plan and a higher accuracy of travel plan recommendation, which can effectively shorten travel duration, reduce the number of transfers, lower travel cost and improve comfort, and then improve the travel experience of users.

The present disclosure further provides a computer program which includes program codes, when the computer program is run by a computer, the program codes carry out the method for recommending a travel plan described in the above embodiments.

It should be understood that steps may be reordered, added or removed using the processes of various forms shown above. For example, the steps described in the present disclosure may be executed in parallel, sequentially, or in different orders, provided that a desired result of the technical solution disclosed in the present disclosure can be achieved, and no limitation is made herein.

The above specific embodiments do not constitute a limitation to the protection scope of the present disclosure. Those skilled in the art should understand that various modifications, combinations, sub-combinations and substitutions can be made according to design requirements and other factors. Any modification, equivalent replacement, improvement and the like made within the spirit and principle of the present disclosure shall be included in the protection scope of the present disclosure.

What is claimed is:

1. A method for recommending a travel plan, comprising:
receiving a query request sent by a terminal device for a travel plan, the query request comprising travel information;
obtaining at least one candidate mixed travel plan from a travel plan database according to the travel information;
obtaining a real-time travel cost parameter of the at least one candidate mixed travel plan, and obtaining travel cost information of the at least one candidate mixed travel plan according to the travel cost parameter; and
selecting an optimum mixed travel plan from the at least one candidate mixed travel plan according to the travel cost information, and sending the optimum mixed travel plan to the terminal device.

2. The method according to claim 1, wherein the travel information comprises an origin, a destination and a travel time;
the obtaining at least one candidate mixed travel plan from a travel plan database according to the travel information, comprises:
obtaining at least one candidate mixed travel plan that has the same origin, destination and travel time from the travel plan database.

3. The method according to claim 1, wherein the travel cost parameter comprises at least one of a total price, a total time consumption, a walking distance and a number of transfers.

4. The method according to claim 2, further comprising:
obtaining a plurality of pairs of a preset origin and a preset destination;
obtaining candidate mixed travel plans for different times according to each pair of the preset origin and the preset destination, and saving in the travel plan database.

5. The method according to claim 4, wherein the obtaining candidate mixed travel plans for different times according to each pair of the preset origin and the preset destination comprises:
obtaining at least one bus-only travel plan according to each pair of the preset origin and the preset destination;
obtaining a plurality of candidate transfer points according to transfer sections of the at least one bus-only travel plan;
creating a preselected transfer plan according to the preset origin, the preset destination and each of the candidate transfer points;
obtaining travel cost information of each preselected transfer plan for the different times;
selecting at least one preselected transfer plan for each of the times according to the travel cost information as the candidate mixed travel plan.

6. The method according to claim 5, wherein the obtaining a plurality of candidate transfer points according to transfer sections of the at least one bus-only travel plan comprises:
for each bus-only travel plan, obtaining at least one of a start bus stop, an end bus stop, a first bus stop within a preset distance from the start bus stop and a second bus stop within the preset distance from the end bus stop, for each of the transfer sections of the bus-only travel plan, as the candidate transfer points.

7. The method according to claim 5, wherein the creating a preselected transfer plan according to the preset origin, the preset destination and each of the candidate transfer points comprises at least one of:
creating a preselected transfer plan with a travel by bus from the preset origin to the candidate transfer point, and a travel by taxi from the candidate transfer point to the preset destination; or
creating a preselected transfer plan with a travel by taxi from the preset origin to the candidate transfer point, and a travel by bus from the candidate transfer point to the preset destination.

8. The method according to claim 5, wherein the obtaining travel cost information of each preselected transfer plan for the different times comprises:
for each of the times, obtaining a travel cost parameter of each preselected transfer plan for the time, and obtaining travel cost information for the time according to the travel cost parameter for the time;
the selecting at least one preselected transfer plan for each of the times according to the travel cost information comprises:
for each of the times, selecting at least one preselected transfer plan according to travel cost information of preselected transfer plans for the time.

9. The method according to claim 5, wherein after the selecting at least one preselected transfer plan for each of the times according to the travel cost information, the method further comprises:
determining at least one of whether a total time consumption of the preselected transfer plan is less than a total time consumption of the bus-only travel plan, or whether a total price of the preselected transfer plan is less than a total time consumption of a taxi-only travel plan;
deleting the preselected transfer plan on a negative determination.

10. An electronic device, comprising:
at least one processor; and
a memory communicatively connected to the at least one processor;
wherein the memory stores thereon instructions executable by the at least one processor, and the at least one processor, when executing the instructions, is configured to:
receive a query request sent by a terminal device for a travel plan, the query request comprising travel information;
obtain at least one candidate mixed travel plan from a travel plan database according to the travel information;
obtain a real-time travel cost parameter of the at least one candidate mixed travel plan, and obtain travel cost information of the at least one candidate mixed travel plan according to the travel cost parameter; select an optimum mixed travel plan from the at least one candidate mixed travel plan according to the travel cost information, and send the optimum mixed travel plan to the terminal device.

11. The device according to claim 10, wherein the travel information comprises an origin, a destination and a travel time;
the at least one processor is configured to obtain at least one candidate mixed travel plan that has the same origin, destination and travel time from the travel plan database.

12. The device according to claim 10, wherein the travel cost parameter comprises at least one of a total price, a total time consumption a walking distance and a number of transfers.

13. The device according to claim 11, wherein the at least one processor is further configured to:
obtain a plurality of pairs of a preset origin and a preset destination;
obtain candidate mixed travel plans for different times according to each pair of the preset origin and the preset destination, and saving in the travel plan database.

14. The device according to claim 13, wherein the at least one processor is configured to:
obtain at least one bus-only travel plan according to each pair of the preset origin and the preset destination;
obtain a plurality of candidate transfer points according to transfer sections of the at least one bus travel plan;
create a preselected transfer plan according to the preset origin, the preset destination and each of the candidate transfer points;
obtain travel cost information of each preselected transfer plan for the different times;
select at least one preselected transfer plan for each of the times according to the travel cost information as the candidate mixed travel plan.

15. The device according to claim 14, wherein the at least one processor is configured to:
for each bus-only travel plan, obtain at least one of a start bus stop, an end bus stop, a first bus stop within a preset distance from the start bus stop and a second bus stop within the preset distance from the end bus stop, for each of the transfer sections of the bus-only travel plan, as the candidate transfer points.

16. The device according to claim 14, wherein the at least one processor is configured to execute at one of:
create a preselected transfer plan with a travel by bus from the preset origin to the candidate transfer point, and a travel by taxi from the candidate transfer point to the preset destination; or
create a preselected transfer plan with a travel by taxi from the preset origin to the candidate transfer point, and a travel by bus from the candidate transfer point to the preset destination.

17. The device according to claim 14, wherein the at least one processor is configured to:
for each of the times, obtain a travel cost parameter of each preselected transfer plan for the time, and obtain travel cost information for the time according to the travel cost parameter for the time;
the select at least one preselected transfer plan for each of the times according to the travel cost information comprises:
for each of the times, selecting at least one preselected transfer plan according to travel cost information of preselected transfer plans for the time.

18. The device according to claim 14, wherein after the selecting at least one preselected transfer plan for each of the times according to the travel cost information, the at least one processor is further configured to:
determine at least one of whether a total time consumption of the preselected transfer plan is less than a total time consumption of the bus-only travel plan, or whether a total price of the preselected transfer plan is less than a total price of a taxi-only travel plan;
delete the preselected transfer plan on a negative determination.

19. A non-transitory computer readable storage medium with computer instructions stored thereon, wherein the computer instructions are used to enable a computer to carry out the method according to claim 1.

20. A method for recommending a travel plan, comprising:
receiving a query request sent by a terminal device for a travel plan, the query request comprising travel information;
obtaining an optimum mixed travel plan from a travel plan database according to the travel information, and sending the optimum mixed travel plan to the terminal device.
